(19) United States
(12) Patent Application Publication
(10) Pub. No.: US 2013/0100033 A1
(43) Pub. Date: Apr. 25, 2013

(54) TOUCH-TYPE SENSING APPARATUS FOR BATHROOM PRODUCT AND CONTROLLING METHOD THEREOF

(71) Applicant: Shanghai Kohler Electronics Ltd., Shanghai (CN)

(72) Inventors: Fangshen Yuan, Shanghai (CN); Jingwen Wu, Shanghai (CN)

(73) Assignee: Shanghai Kohler Electronics Ltd., Shanghai (CN)

(21) Appl. No.: 13/716,023

(22) Filed: Dec. 14, 2012

Related U.S. Application Data
(63) Continuation of application No. 13/458,889, filed on Apr. 27, 2012, now abandoned.

(30) Foreign Application Priority Data
Apr. 29, 2011 (CN) 201110110321.3

(51) Int. Cl. G06F 3/044

(52) U.S. Cl. CPC G06F 3/044
USPC 345/172

(57) ABSTRACT

A touch sensing device for a kitchen or bath appliance includes a control panel. A sensing guide and a plurality of sensing function keys are provided on the control panel. The sensing guide and the plurality of sensing function keys operate via capacitive touch sensing. The plurality of sensing function keys correspond to a plurality of functions of the kitchen or bath appliance. The touch sensing device further includes a controller connected to the sensing guide, the plurality of sensing function keys, and the kitchen or bath appliance. The controller is configured to activate the control panel after the controller detects that the sensing guide has been touched in a predetermined manner. Activating the control panel can include enabling capacitive touch sensing for the plurality of sensing function keys.

### CROSS-REFERENCE TO RELATED APPLICATIONS

This application is a continuation of U.S. application Ser. No. 13/458,889, filed Apr. 27, 2012, which claims the benefit of Chinese Patent Application No. 201110110321.3, filed Apr. 29, 2011, the entirety of which is incorporated herein by reference.

### FIELD OF THE INVENTION

The present invention relates to a touch sensing device and control method. The touch sensing device further relates to a touch sensing device and control method for a kitchen or bath appliance.

### BACKGROUND OF THE INVENTION

In the prior art, the control panel of a kitchen or bath appliance conventionally includes mechanical buttons (i.e., switches, keys, etc.). For example, the control panel for controlling a faucet, a bathtub, a shower or the like conventionally includes a mechanical-push-type or piezoelectric-type buttons. However, such a mechanical button tends to fail due to repeated structural compression, and effective water sealing cannot be realized by such a mechanical button. Touch sensing technology has gradually been applied in the kitchen and bath industry.

In general, a touch sensing device for a kitchen and bath appliance in the prior art includes a capacitive or resistive touch sensing device. The working principle of a capacitive touch sensing device is that a capacitance is changed by a conductor (e.g., a human hand) touching near a portion of a touch sensor element (e.g., an electrode). A detecting circuit processes the capacitance change to determine whether a button of the touch sensing device has been pressed.

As the kitchen and bath appliances are usually used in a watery environment, such as a tap, bathtub, shower bath or the like, touching water is inevitable. The sensors on the touch sensing device tend to be disturbed by water drops, water flow or a nearby column of water, which causes errors in operation. There is a need to eliminate or reduce the influence of water on the touch sensing device.

Furthermore, the addition of complicated lighting effects on kitchen or bath appliances can prevent a user from correctly identifying the current status of a control system button.

### SUMMARY OF THE INVENTION

One object of the present invention is to provide a touch sensing device for a kitchen or bath appliance that reduces the errors caused by water.

According to one embodiment of the invention, a touch sensing device for a kitchen or bath appliance includes a control panel and a controller.

A sensing guide (i.e., strip or channel having a plurality of touch sensing elements) and one or a plurality of sensing function keys (i.e., touch sensitive buttons for control of kitchen or bath appliance functions) are provided on the control panel, and are capacitive touch sensing key elements (i.e., that operate via capacitive touch sensing). The plurality of sensing function keys may correspond to functional modules of the kitchen or bath appliance.

A controller is connected to the sensing guide, the one or plurality of sensing function keys, and the plurality of functional modules. Changes in capacitance of the sensing guide are detected. The controller causes the control panel to change to an active state after it is detected that the sensing guide has been touched in a predetermined manner. In the active state, the controller can detect whether the sensing function keys have been touched. If the sensing function keys are touched, the controller controls the corresponding functional module (e.g., to perform the corresponding kitchen or bath function).

The touch sensing device may include a sensing guide LED positioned to illuminate the sensing guide and a plurality of sensing function key LEDs positioned to illuminate the plurality of the sensing function keys.

The controller may be connected to the sensing guide LED and the plurality of sensing function key LEDs. When the controller sets the control panel to an active state, the controller causes the sensing guide LED and the plurality of sensing function key LEDs to illuminate according to a first mode of operation. Upon detecting, in the active state, that the sensing guide and/or the sensing function key are in use, the controller may control the sensing guide LED and/or the sensing function key LEDs to change to a second mode. After use, the controller causes sensing guide LED and/or the sensing function key LEDs to return to the first mode.

The sensing guide LED and the plurality of sensing function key LEDs may be color-changeable LED lamps. The controller may cause the LEDs to be a first color if in the first mode and a second color if in the second mode.

The sensing guide LED and the plurality of sensing function key LED may alternatively be luminance-changeable LED lamps. The controller may cause the LEDs to be a first luminance if in the first mode and a second luminance if in the second mode.

The sensing guide LED and the plurality of sensing function key LEDs may alternatively be flicker frequency-changeable LED lamps. The controller may cause the LEDs to flicker at a first frequency if in the first mode and to flicker at a second frequency if in the second mode.

The sensing guide LED and the plurality of sensing function key LEDs may be respectively provided beneath positions corresponding to the sensing guide and the plurality of the sensing function keys. In other embodiments, the sensing guide LED and the sensing function LEDs may be respectively provided at positions around the sensing guide and the plurality of the sensing function keys.

The sensing guide may be longitudinal type (i.e., elongated) and the sensing guide LEDs may be arranged in at least one row (i.e., array) of LEDs along the longitudinal sensing guide. Upon detecting that the control panel should be set to an active state, the controller can cause each LED in the row of the LEDs to turn on in sequence.

In an exemplary embodiment, the plurality of the sensing function keys includes at least one key for adjusting a functional parameter of the kitchen or bath appliance and at least one ON/OFF key for the kitchen or bath appliance. After detecting that the key for adjusting the functional parameter has been touched, the controller can detect a capacitance change of the touch sensors of the sensing guide and can adjust the corresponding functional parameters based on the detected capacitance change. In this way, the sensing guide may be used to control the magnitude of the functional parameter selected for changing by touching a sensing function key. The magnitude of the functional parameter may be graphically indicated by controlling the number or positions of the LED lamps that turn on in the LED row of the longitudinal sensing guide.

If the ON/OFF key is touched while the control panel is on, the controller sets the control panel to an inactive state and controls the sensing guide LEDs and the plurality of sensing function key LEDs to turn off.

In an exemplary embodiment, the touch sensing device includes a display screen. The controller may be connected to the display screen to cause the display screen to graphically indicate the current functional parameters set by the sensing guide and/or the sensing function keys.

Another embodiment of the invention relates to a method for controlling a touch sensing device for a kitchen or bath appliance. After detecting that the sensing guide has been touched in a predetermined manner, the controller sets the control panel to an active state. When the control panel is in an active state and a sensing function key has been touched, the controller causes a corresponding functional module to perform its function.

The method may include providing a sensing guide LED for the sensing guide and providing a sensing function key LED for each sensing function key. The method may further include providing two modes for the sensing guide LED and the sensing function key LED.

After detecting that the sensing guide or any of the sensing function keys has been touched in a predetermined manner (e.g., a finger has been slid along the guide channel, activating the series of associated capacitive sensors associated with the sensing guide), the controller controls the sensing guide LED or LEDs and each sensing function key LED to turn on in the first mode. If the sensing guide has not been touched in a predetermined manner, the controller panel is kept in an inactive state.

After detecting that a sensing function key has been touched, the controller causes the corresponding sensing function key LED to turn on in a second mode. After controlling the kitchen or bath functional module corresponding to the touched sensing function key, the controller causes the sensing function key LED light source to return to the first mode.

The sensing guide LED or LEDs and the plurality of sensing function key LED may be color-changeable LED lamps. The LEDs may be illuminated as a first color if in the first mode and illuminated as a second color if in the second mode.

In other embodiments, the sensing guide LED or LEDs and the plurality of sensing function key LED may be luminance-changeable LED lamps. The LEDs may be set to a first luminance if in the first mode and set to a second luminance if in the second mode.

In yet other embodiments, the sensing guide LED or LEDs and the plurality of sensing function key LEDs may be flicker frequency-changeable LED lamps. The LEDs may be set to a first flicker frequency if in the first mode and set to a second flicker frequency if in the second mode.

The sensing guide may be elongated and the LEDs of the sensing guide may be arranged in at least one row of the LEDs (i.e., an array) arranged along the longitudinal axis of the sensing guide. Controlling the sensing guide LEDs to turn on in the first mode may include controlling the LEDs of the array to turn on in sequence.

In an exemplary embodiment, the plurality of the sensing function keys includes at least one key for adjusting a functional parameter of the kitchen or bath appliance and one ON/OFF key. The method may include a step for allowing a user to adjust the functional parameter. After detecting that the key for adjusting a functional parameter has been touched, the controller can use a detected the capacitance change of the sensing guide to adjust the selected functional parameter. For example, sliding a finger some distance along the sending guide can indicate the desired magnitude of the functional parameter. The controller can change the number or position of the LEDs to turn on in the LED array of the sensing guide (e.g., to provide feedback regarding the selected magnitude to the user). The controller can also or alternatively display the functional parameter changes on a separate display screen.

In an exemplary embodiment, the method may include a process for setting the control panel to an inactive state. If the controller detects that the ON/OFF key has been touched while the panel is active, the controller can set the control panel to an inactive state and can control the sensing guide LED or LEDs and the plurality of sensing function key LEDs to turn off.

The step of judging whether or not the sensing guide has been touched in a predetermined manner can be conducted by detecting whether or not the capacitance of the sensing guide's sensors has changed in a preset order or direction (e.g., left to right, right to left, etc.). If the sensing guide's capacitive sensors have changed capacitance in order, it is determined that the sensing guide has been touched in a predetermined manner. If the sensing guide's capacitive sensors have not changed capacitance in order, it is assumed that the sensing guide has not been touched in a predetermined manner (e.g., protecting against activation due to, e.g., water interference).

In an exemplary embodiment, the method further includes a process of setting the control panel back to an inactive state. The process can include setting a timer on the controller after a last sensed touch. If the controller does not detect that the sensing guide or any of the sensing function keys has been touched within the preset time, the control panel is switched back to the inactive state.

When setting the control panel to an inactive state, the controller can store the states of the sensing guide and each of the sensing function keys in memory.

According to varying embodiments of the invention, the touch sensing device for a kitchen or bath appliance and the control method thereof utilize a sensing guide on a control panel to determine whether the control panel should be activated. In an exemplary embodiment, the control panel is activated only upon detecting that the sensing guide has been touched in a predetermined manner. Only after the control panel is activated will a sensing function key of the control panel perform the corresponding function after being touched. Since the probability of water touching the sensing guide in the predetermined manner is very small, the error caused by water can be reduced through embodiments of the present invention.

In some embodiments, a sensing guide LED (or LEDs) is provided for the sensing guide, a sensing function key LED is provided for each sensing function key, and only two modes for the LEDs are provided. This configuration may advantageously enable the user to quickly and effectively identify the current status. The user may not need to spend significant time understanding the status of the system and the apparent complexity of the operation may be decreased.

The present invention discloses a touch sensing device for a kitchen or bath appliance. The device includes a control panel and a controller. A sensing guide and one or a plurality of sensing function keys are provided on the control panel, and are or include capacitive touch sensors. The plurality of sensing function keys may respectively correspond to a plurality of functional modules of the kitchen or bath appliance. The controller is connected to the sensing guide, the one or plurality of sensing function keys, and the plurality of functional modules. Changing capacitance of the sensing guide is evaluated, and the control panel is set to an active state after a determination that the sensing guide has been touched in a predetermined manner. In an active state, the control panel's sensing function keys are active. Once a sensing function key is determined to have been touched, the controller causes the corresponding functional module to perform its function.

According to another embodiment of the invention, a touch sensing device for a kitchen or bath appliance includes a control panel. A sensing guide and a plurality of sensing function keys are provided on the control panel. The sensing guide and the plurality of sensing function keys operate via capacitive touch sensing. The plurality of sensing function keys correspond to a plurality of functions of the kitchen or bath appliance. The touch sensing device further includes a controller connected to the sensing guide, the plurality of sensing function keys, and the kitchen or bath appliance. The controller is configured to activate the control panel after the controller detects that the sensing guide has been touched in a predetermined manner. Activating the control panel can include enabling capacitive touch sensing for the plurality of sensing function keys.

### BRIEF DESCRIPTION OF THE FIGURES

FIG. 1 is a structural diagram of a control panel of the touch sensing device, according to an exemplary embodiment;

FIG. 2a is block circuit diagram of the touch sensing device of FIG. 1, according to an exemplary embodiment;

FIG. 2b is a block circuit diagram of a touch sensing device, according to another exemplary embodiment;

FIG. 3 is a structural diagram of the control panel in yet another embodiment;

FIG. 4 is a flow diagram of a method for use with the control panel of FIGS. 1 and 2, according to an exemplary embodiment; and

FIG. 5 is another flow diagram of a method for use with the control panel of FIGS. 1 and 2, according to an exemplary embodiment.

### DETAILED DESCRIPTION

The present invitation relates to a touch sensing device and control method for a kitchen or bath appliance. A sensing guide (i.e., elongated finger guide, elongated depression, elongated channel, strip of sensors, line of sensors, series of sensors, etc.) is provided on the control panel. The control panel is activated only after detecting that the sensing guide has been touched in a predetermined manner (e.g., a finger has been moved along the guide, causing capacitance changes to be detected in an order). Only after the control panel is activated, the sensing function keys of the control panel are activated for triggering a corresponding function in response to detected touches. The touch sensing device thus reduces errors resulting from water on or near the sensing function keys.

The present invention is described in more detail with reference to the exemplary embodiments and the attached drawings.

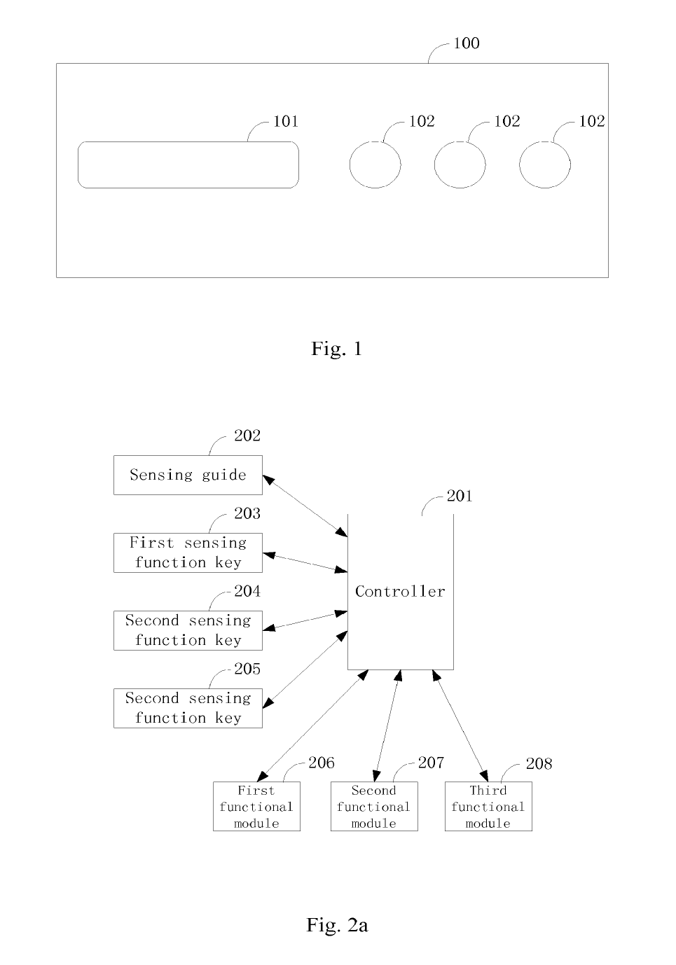

Referring now to FIG. 1, the touch sensing device is shown to include a control panel 100 and a controller. A longitudinal sensing guide 101 and three sensing function keys 102 are provided on the control panel 100. The sensing guide 101 and the three sensing function keys 102 of this embodiment are capacitive touch sensing elements (e.g., are operated in response to detected capacitance changes or changes in other electrical properties effected by changing capacitance).

The touch sensing device can be used for a kitchen or bath appliance. For example, the touch sensing device can be used for a bathtub, a shower, a faucet or another kitchen or bath appliance. The three sensing function keys 102 can vary according to the accompanying appliance. In a bathtub, shower, or faucet example, the three sensing function keys may include an on/off key, a water regulating key, and a water temperature regulating key. In other embodiments, two or more than three sensing function keys 102 may be provided.

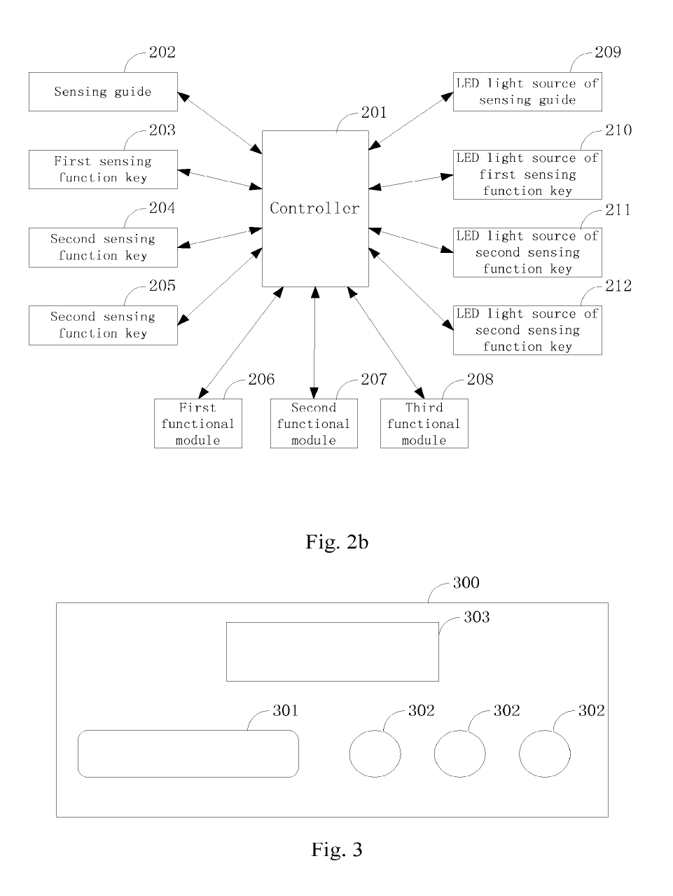

The circuit diagram of the touch sensing device of FIG. 1 is shown in FIG. 2a. In FIG. 2a, the touch sensing device is shown to include a controller 201, a sensing guide 202, a first sensing function key 203, a second sensing function key 204 and a third sensing function key 204. The guide and the keys are electrically connected to the controller 201.

As shown in FIG. 2a, the controller 201 is also connected to a first functional module 206, a second functional module 207, and a third functional module 208 of the kitchen or bath appliance.

The first sensing function key 203 may be an on/off key, the second sensing function key 204 may be a water regulating key, and the third sensing function key 205 may be a temperature regulating key.

The first sensing function key 203 corresponds to the first functional module 206. The second sensing function key 204 corresponds to the second functional module 207. The third sensing function key 205 corresponds to the third functional module 208.

The controller 201 detects capacitance changes of the sensing guide 202, the first sensing function key 203, the second sensing function key 204 and the third sensing function key 205. The control panel is set to an active state (that is, both the sensing guide and the sensing function key are set to an active state) after the controller detects that the sensing guide 202 has been touched in a predetermined manner. The predetermined manner can correspond with the shape of the sensing guide 202. For example, if the sensing guide 202 is rectangular (see FIG. 1), the predetermined manner may be that the touch on the sensing guide 202 is a swipe straight from one end of the sensing guide 202 to the other end. If the sensing guide 202 is in an arc-shape or other shape, the predetermined manner may be that the touch on the sensing guide 202 is a swipe from one end of the sensing guide 202 to the other end thereof along the shape of the sensing guide 202 (e.g., in an arc).

Upon detecting the capacitance change of the first sensing function key 203, the second sensing function key 204, or the third sensing function key 205 by the controller 201 in an active state, the controller controls the first functional module 206, second functional module 207, or third functional module to perform the corresponding function.

According to an exemplary embodiment, the controller 201 can set the control panel to an inactive state (or a dormant state) in two ways, and these two ways can be used either separately or simultaneously. The first way to enter the inactive state is upon expiration of a timer. If no capacitance change of the sensing guide 202 or any sensing function key 203-205 is detected within the preset time, such as 30 seconds, one minute, two minutes or the like, the control panel will be changed to an inactive state. In this case, the control panel must be activated again (e.g., via the sensing guide) to continue to use this kitchen and bath appliance. The second way to enter the inactive state is to use one of the sensing function keys as the on/off key. For example, upon detecting that the first sensing function key 203 has been touched for a second time, the controller 201 changes the control panel to an inactive state.

Referring now to FIG. 2b, the touch sensing device includes a controller 201 connected to a sensing guide 202, a first sensing function key 203, a second sensing function key 204, a third sensing function key 205, a LED light source 209 of the sensing guide, a LED light source 210 of the first sensing function key, a LED light source 211 of the second sensing function key, and a LED light source of the third sensing function key. As shown in FIG. 2b, the controller 201 is also connected to the first functional module 206, the second functional module 207, and the third functional module 208 of the kitchen or bath appliance.

According to an exemplary embodiment, the first sensing function key 203 is an ON/OFF key, the second sensing function key 204 is a water regulating key, and the third sensing function key 205 is a temperature regulating key.

The sensing guide 202 corresponds to LED light source 209 of the sensing guide. The first sensing function key 203 corresponds to the first functional module 206 and the LED light source 210 of the first sensing function key. The second sensing function key 204 corresponds to the second functional module 207 and the LED light source 211 of the second sensing function key. The third sensing function key 205 corresponds to the third functional module 208 and the LED light source 212 of the third sensing function key.

The LED light source 209 of the sensing guide and the LED light sources 210-212 of the three sensing function keys are provided at the positions corresponding to the sensing guide 202 and the three sensing function keys 203-205. In varying embodiments, the LED light sources can be configured to provide light to the sending guide and the sensing function keys from different positions (e.g., beneath the guide, beneath the sensing function keys, offset to one side, etc.).

After detecting the sensing guide 202 has been touched in a predetermined manner, the control panel is set to an active state (i.e., ready for capacitive detection relative to the sensing function keys). In the active state, the controller 201 causes the LED light source 209 of the sensing guide, the LED light source 210 of the first sensing function key, the LED light source 211 of the second sensing function key, and the LED light source 212 of the third sensing function key to turn on according to a first mode of illumination.

Upon detecting, while in the active state, a capacitance change of a sensing function key (that is, the sensing function key has been touched), the controller 201 causes the proper functional module to perform the module's function, and controls the corresponding LED light source to turn on according to a second mode (e.g., which may look different than an LED light source illuminated according to the first mode). After the selected functional module finishes the corresponding function (or discontinues controlling the corresponding function), the controller 201 controls the corresponding LED light source to revert to the first mode of illumination.

In other words, the LED light sources of FIG. 2b can turn on in two modes. The first mode indicates that the corresponding sensing guide or sensing function key is in an active state. The second mode indicates that the corresponding sensing guide or sensing function key is in use.

The two illumination modes can be provided in varying ways according to varying embodiments. For example, the two illumination modes may be provided using color-changeable LED lamps, with the modes distinguished by different colors (for example, yellow may represent the first mode—active state, while green may represents the second mode—in use). In another example, luminance-changeable LED lamps may distinguish modes using different luminance levels (e.g., high luminance may represent the second mode—in use, low luminance may represent the first mode—active state). In yet another example, flicker frequency-changeable LED lamps may distinguish modes using different flashing frequencies. For example, a first flashing frequency may indicate the active state and a second frequency can represents the in use state).

In varying embodiments, certain functional parameters of the kitchen or bath appliance can be adjusted by the sensing guide 202. In other words, the sensing guide 202 may be used for functional parameter adjustment after the sensing guide 202 is used to active the control panel. Upon detecting (in the active state) a capacitance change of the second sensing function key 204 or the third sensing function key 205, the controller 201 controls one or more corresponding LED light sources to turn on according to the second illumination mode (i.e., “in use”). The controller 201 can then detect the capacitance change of the sensing guide 202 and can cause the adjustment of the parameters corresponding to the initially selected sensing function key (i.e. water yield or temperature). Varying capacitance patterns (e.g., varying swipe lengths) on the sensing guide can result in varying parameter adjustment. The controller 201 can forward the parameter adjustment to the appropriate functional module. For example, the second functional module 207 or the third functional module 208 can perform the corresponding function according to the parameter adjustment.

After the second functional module 207 or the third functional module 208 finishes the corresponding function, or discontinue the corresponding function, the controller 201 causes the sensing guide LED light source or the sensing function LED light sources to return to the first mode of illumination.

In varying embodiments, the LED light source 209 of the sensing guide can be realized by either a single LED lamp or a plurality of LED lamps. In certain embodiments, the LED light source 209 of the sensing guide can be provided by at least one row of an LED array arranged along the longitudinal sensing guide 202. For example, if the sensing guide 202 is 10cm long, the LED array may include 10 LED lamps uniformly distributed on the 10cm long sensing guide 202. In varying embodiments, any number of LEDs may form the LED array.

Upon detecting the capacitance change of the sensing guide 202 or of any of the sensing function keys 203-205 on the control panel, the controller 201 can control at least one row of LED array to turn on in the first mode according to a preset sequence, to indicate that the user may touch the sensing guide 202 according to the preset sequence to activate the control panel. Such an arrangement encourages the user to touch the sensing guide 202 according to the lighting indication of LED light source 209 of the sensing guide.

While adjusting the functional parameters using the sensing guide 202, the controller 201 can obtain the last position touched by the user according to the capacitance change. This last position may be used to control the LED array to turn on in the second mode of illumination and to indicate the magnitude of the corresponding functional parameters. For example, in the context of temperature regulation control, the controller 201 may cause 2 LED lamps in the LED array to turn on, to indicate that the temperature is relatively low. On the other hand, the controller 201 may cause the 6 LED lamps in the LED array to turn on to indicate that the temperature is relatively high.

In some embodiments, the controller 201 can also change the control panel to inactive state (or dormant state) in two ways. The two ways can be used separately or simultaneously. The first is to change the control panel to the inactive state if no capacitance change of the sensing guide 202 or any sensing function key 203-205 is detected within a preset time, such as 30 seconds, one minute, two minutes or the like. In the inactive state, the LED light source 209 of the sensing guide and the LED light sources 210-212 of all the sensing function keys may turn off. The second way to change the control panel to an inactive state is to use an ON/OFF key. For example, upon detecting that the first sensing function key 203 has been touched for a second time, i.e. the operation instruction of the on/off key is off, the controller 201 can change the control panel to the inactive state.

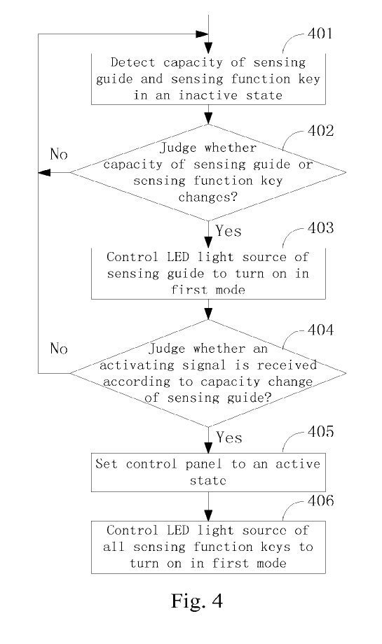

Referring now to FIG. 4, a procedure for activating the control panel is shown, according to an exemplary embodiment. Before being used, the control panel is in an inactive state or dormant state, and the LED light source of the sensing guide and the LED light source of each sensing function key is off.

Step 401 is to detect the capacitances of the sensing guide and the sensing function key while the control panel in an inactive state. When the user touches the sensing guide or a sensing function key, the controller can detect the capacitance change of the sensing guide or the sensing function key.

Step 402 is to judge whether or not the capacitances of the sensing guide or the sensing function key changes. If yes, step 403 is performed. If no, the process returns to step 401.

Step 403 is to control the LED light source of the sensing guide to turn on in the first mode. This intent of this step is to instruct or entice the user to touch the sensing guide, so as to activate the control panel. In this step, if the LED light source of the sensing guide is provided by a row of the LED array arranged along the sensing guide, the controller will cause this row of the LED array to turn on according to preset sequence. The lighting sequence may instruct the user to touch the sensing guide in a predetermined manner, thus activating the control panel. Such an arrangement shows the user how to touch the sensing guide (i.e., according to the LED light source of the sensing guide) for activation of the control panel.

Step 404 is to judge whether or not a correct activating signal is received according to the capacitance change of the sensing guide. If the correct activating signal is received, the process continues to Step 405. If the correct activating signal is not received, the process returns to Step 401. In this step, the controller receives and processes the capacitance change signal of the sensing guide, then judges whether or not the user has touched the sensing guide in the predetermined way. If the user touched the sensing guide in the predetermined way, then the controller determines that the activating signal was received. When the user's hand slides on the sensing guide in a predetermined manner, the capacitance of the sensing guide will change in a preset sequence. The controller identifies and processes the capacitance change signal received from the sensing guide. In an example, if the control panel is horizontally installed on a kitchen or bath appliance, the preset way may be either from left to right or from right to left. If the control panel is vertically installed on a kitchen or bath appliance, the preset way may be either from bottom to top or from top to bottom.

Step 405 is to set the control panel to an active state. One or more substeps may be associated with Step 405. Step 406 is to cause the LED light source of all the sensing function keys to turn on in the first mode. At this time, the LED light source of the sensing guide and the LED light sources of all the sensing guides will turn on in the first mode, communicating that the control panel is in an active state. In the active state, the control panel can provide a general illuminant effect intended to allow the user to clearly see the state of the sensing guide and each sensing function key on the control panel. The kitchen or bath appliance can be controlled through the control panel after the control panel is activated.

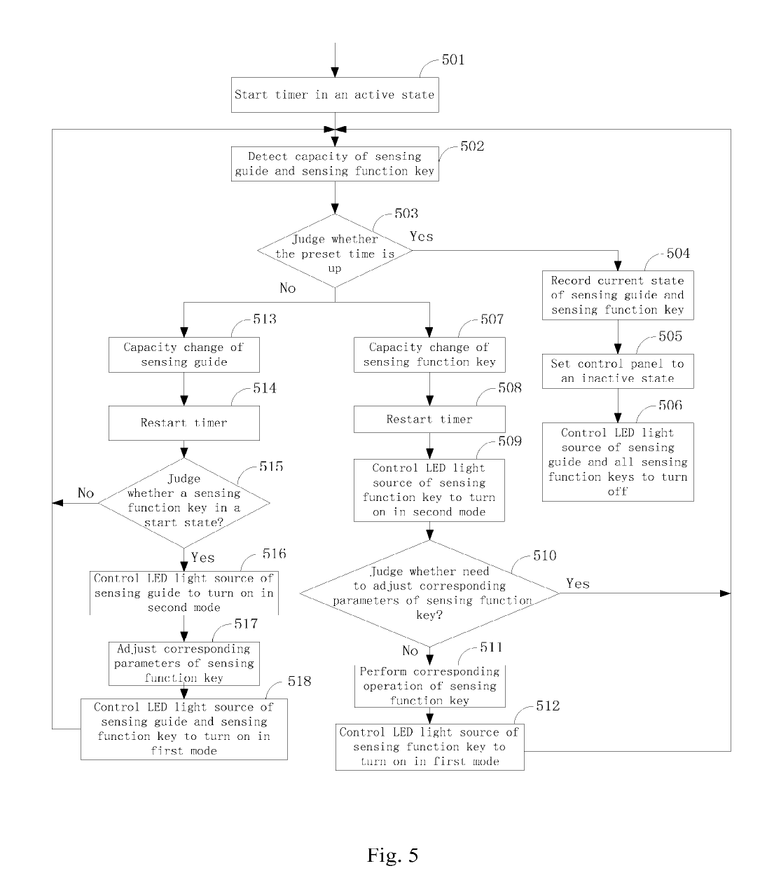

Referring now to FIG. 5, a processing procedure of the control panel in an active state (e.g., after entering the active state in FIG. 4) is shown, according to an exemplary embodiment. Step 501 is to start the timer when the control panel enters the active state. The timer is used to determine whether to later change the state to an inactive state.

Step 502 is to detect the capacitance of the sensing guide and of each sensing function key. Step 503 is to judge whether or not the preset time is reached (i.e., whether the timer has counted down to zero). If the preset time is reached, Step 504 is initiated. If the preset time is not reached, Steps 507 and/or 513 are initiated depending on whether there has been a capacitance change of the sensing guide (Step 513) or a capacitance change of a sensing function key (Step 507).

Step 504 is to record the current states of the sensing guide and each sensing function key. In the next use, when the user operates a certain sensing function key, or if the sensing function key needs a parameter adjustment, the controller will recall the recorded states so that the control panel can resume operation.

Step 505 is to set the control panel to an inactive state (dormant state). Step 506 is to control the LED light source of the sensing guide and the LED light source of each sensing function key to turn off.

As an example of the timer operation of FIG. 5, if within the preset time (e.g., 1 minute, 2 minutes, longer, etc.) no capacitance change is detected for the sensing guide or any sensing function key, then the control panel will be changed to an inactive state.

Step 507 is to detect the capacitance change for a certain sensing function key. In response to detecting the capacitance change, in Step 508 the timer is restarted. The capacitance change of a certain sensing function key may represent that the user is still using the kitchen or bath appliance. Therefore, the timer is restarted to avoid expiration of the timer.

Step 509 is to control the LED light source of the sensing function key to turn on according to the second mode of illumination. When the LED light source of the sensing function key turns on in the second mode, the illumination can communicate to the user that the user is actively using the sensing function key.

Step 510 is to judge whether or not it is necessary to adjust the functional parameters associated with the sensing function key. If it is necessary, then the process returns to Step 502. If it is not necessary to adjust the functional parameter or parameters associated with the sensing function key, then the process initiates Step 511.

In Step 510, the controller judges whether or not it is necessary to adjust the functional parameters of the sensing function key. For example, the pressed second sensing function key corresponds to the temperature regulating function, and may it be necessary to adjust the functional parameters (e.g., temperature) corresponding to the sensing function key. Step 511 is to perform the corresponding operations (e.g., temperature adjustment) of the sensing function key. If it is unnecessary to adjust the parameters of the sensing function key, then the controller may directly perform the corresponding operations of the sensing function key. For example, in this embodiment, the first sensing function key is an ON/OFF key; after it is touched, the controller will directly cause the kitchen or bath appliance to start, power-up, or otherwise begin operation. If the ON/OFF key is touched for a second time, the controller may judge the second touch as an off instruction. At this time the controller may jump to Steps 504-506 and cause the kitchen or bath appliance to deactivate or close.

Step 512 is to control the LED light source of the sensing function key to turn on in the first mode. Once Step 512 is triggered, the process may return to Step 502. The illumination mode caused by Step 512 can indicate that the corresponding function of the sensing function key has been performed, and the sensing function key has returned from the use state (associated with the second lighting mode) to the active state (associated with the first lighting mode).

Step 513 is to detect capacitance change of the sensing guide. Step 514 is to restart the timer. The capacitance change of a sensing guide indicates that the user is still using the kitchen or bath appliance. Accordingly, the timer is restarted to avoid expiration.

Step 515 is to judge whether or not any sensing function key is in use. If yes, then the controller performs Step 516 and otherwise returns to Step 502. If no any sensing function key is in use, it may be inferred that the sensing guide is receiving capacitance changes in error (e.g., due to water). Accordingly, the process returns to Step 502 without changing modes or conducting adjustments.

Step 516 is to control the LED light source of the sensing guide to turn on in the second mode. The LED light source of the sensing guide turning on in the second mode may indicate that the user is using the sensing guide to adjust the functional parameters, i.e. the sensing guide is in use. In this step, if the LED light source of the sensing guide is realized by a row of an LED array, the controller may control this row of the LED array to turn on the corresponding LED lamp in the second mode (e.g., a high level of brightness) according to the position of the sensing guide touched by the user. This can indicate the current or commanded magnitude of the functional parameters being adjusted by the user.

Step 517 is to adjust the corresponding functional parameters of the sensing function key and control the corresponding functional module to perform the corresponding function. In this step, the corresponding functional parameters of the sensing function key are adjusted according to the position of the sensing guide touched by the user.

Step 518 is to control the LED light source of the sensing guide and the LED light source of the sensing function key to turn on in the first mode. Return to Step 502. The illumination change of this step indicates that the adjustment of the functional parameters and execution of the corresponding function are finished, and the sensing guide and sensing function key are restored from the “in use” state to the active (but not “in use”) state.

Referring now to FIG. 3, a control panel includes a display for showing the adjusted functional parameters (rather an LED light source 209 of the sensing guide displaying the adjusted functional parameters). Such a control panel 300 is shown in FIG. 3, including a longitudinal sensing guide 301, three sensing function keys 302 as well as a display screen 303. The display screen may be eclectically connected to the controller. While the controller is executing adjustment of the functional parameters, the updated functional parameters may be displayed on the display screen. The display screen 303 may be any LED or LCD display screen which can be provided on the control panel 300.

Embodiments of the disclosed touch sensing device for a kitchen or bath appliance, and the method for controlling the same, can advantageously reduce the error operation caused by water. In some embodiments, the LED light source of the sensing guide and the LED light source of the sensing function keys are separately controlled, increasing the ease with which the user can identify the current state of the touch sensing device.

What is claimed is:

1. A touch sensing device for a kitchen or bath appliance, comprising:
a control panel;
a sensing guide and a plurality of sensing function keys are provided on the control panel, wherein the sensing guide and the plurality of sensing function keys operate via capacitive touch sensing, and wherein the plurality of sensing function keys correspond to a plurality of functions of the kitchen or bath appliance;
a controller connected to the sensing guide, the plurality of sensing function keys, and the kitchen or bath appliance;
wherein the controller is configured to activate the control panel after the controller detects that the sensing guide has been touched in a predetermined manner, wherein activating the control panel comprises enabling capacitive touch sensing for the plurality of sensing function keys.

2. The touch sensing device of claim 1, further comprising:
a first light source positioned to illuminate the sensing guide; and
a plurality of light sources positioned to illuminate the plurality of the sensing function keys.

3. The touch sensing device of claim 2, wherein the controller is connected to the first light source and the plurality of light sources positioned to illuminate the plurality of sensing function keys, and wherein the controller changes first light source and the plurality of light sources from a first mode to a second mode when the control panel is activated.

4. The touch sensing device of claim 2, wherein the first light source and the plurality of light sources positioned to illuminate the plurality of sensing function keys are color-changeable LEDs which are a first color in the first mode and a second color in the second mode.

5. The touch sensing device of claim 2, wherein the first light source is provided beneath the sensing guide.

6. The touch sensing device of claim 2, wherein the first light source is provided around the sensing guide.

7. The touch sensing device of claim 2, wherein the sensing guide is an elongated guide on the control panel and the first light source is at least one row of a LED array arranged along the longitudinal axis of the sensing guide.

8. The touch sensing device of claim 7, wherein the controller, upon detecting that the control panel is set to an active state, causes each LED lamp in at least one row of the LED array to turn on in sequence.

9. The touch sensing device of claim 1, wherein the plurality of the sensing function keys comprise at least one key for adjusting a functional parameters of the kitchen or bath appliance and at least one ON/OFF key.

10. The touch sensing device of claim 9, wherein the controller, after detecting that the key for adjusting the functional parameters has been touched, detects a capacitance change of the sensing guide and adjusts the corresponding functional parameters based on the detected capacitance change, wherein the controller is further configured to indicate the magnitude of the functional parameters by controlling the number and positions of LED lamps that turn on in an LED array positioned to illuminate the sensing guide.

11. A method for operating a touch sensitive control panel of a kitchen or bath appliance, comprising:
detecting that an sensing guide has been touched in a predetermined manner;
activating a plurality of functional touch sensitive keys in response to detecting that the sensing guide was touched in the predetermined manner;
detecting that one of the plurality of functional touch sensitive keys has been touched; and
causing the kitchen or bath appliance to execute the function associated with the touched functional touch sensitive keys.

12. The method of claim 11, wherein the sensing guide is an elongated strip or channel.

13. The method of claim 12, wherein the predetermined manner is a swipe of a finger along the length of the elongated strip or channel.

14. The method of claim 13, wherein the control panel includes a sensing guide LED light source for the sensing guide and a sensing function key LED light source for each sensing function key, wherein the method further comprises: providing two on modes for the sensing guide LED light source and the sensing function key LED light sources.

15. The method of claim 14, further comprising:
after detecting that a sensing function key has been touched, controlling the corresponding sensing function key LED light source to turn on according to a second illumination mode;
after controlling a functional module corresponding to the sensing function key to perform the corresponding function, causing the sensing function key LED light source to return to a first mode.

16. The method of claim 15, wherein the sensing guide LED light source and the sensing function key LED light sources include at least one of: color-changeable LED lamps, luminance-changeable LED lamps, and flicker-changeable LED.

17. The method of claim 11, wherein the sensing guide is an elongated strip or channel illuminated by an LED array arranged along the longitudinal axis of the sensing guide, wherein the method further comprises controlling LEDs of the LED array to turn on in sequence to draw attention to the order or direction of the sensing guide.

18. The method of claim 18, wherein determining whether or not the sensing guide was touched in the predetermined manner comprises determining whether capacitive sensors of the sensing guide were touched in a preset order corresponding with the on sequence of the LED array.

19. The method of claim 11, further comprising:
using a timer to change the plurality of functional touch sensitive keys from the active state to a deactivated state.

20. The method of claim 19, further comprising:
changing a lighting state of the control panel to indicate that the plurality of functional touch sensitive keys have been deactivated.
